(19) United States
(12) Patent Application Publication
(10) Pub. No.: US 2016/0335642 A1
(43) Pub. Date: Nov. 17, 2016

(54) CARD VERIFICATION SYSTEM AND METHOD FOR DETECTING CARD ILLEGAL USE

(71) Applicant: NOMURA RESEARCH INSTITUTE, LTD., Tokyo (JP)

(72) Inventors: Hajime SOGAWA, Tokyo (JP); Masahiro UENO, Tokyo (JP); Yohei OTA, Tokyo (JP)

(73) Assignee: NOMURA RESEARCH INSTITUTE, LTD.

(21) Appl. No.: 15/220,551

(22) Filed: Jul. 27, 2016

Related U.S. Application Data
(63) Continuation of application No. PCT/JP2015/055255, filed on Feb. 24, 2015.

(51) Int. Cl. G06Q 20/40; G06Q 20/34

(52) U.S. Cl. CPC G06Q 20/4016; G06Q 20/34; G06Q 20/409

(57) ABSTRACT

A fraud detection-use card information storage unit stores card information indicating that subsequent use of a card is regarded as illegal use. An illegal use information notification unit notifies a given information system about illegal use of the card, including the location where a fraudulent card was used, when a settlement system receives a settlement request from a card reading terminal device with card information identical to card information registered in the fraud detection-use card information storage unit.

### CROSS-REFERENCE TO RELATED APPLICATIONS

This application is a continuation of and claims priority to PCT/JP2015/055255 filed Feb. 24, 2015, the entire contents of which are incorporated herein by reference.

### BACKGROUND OF THE INVENTION

1. Field of the Invention

The present invention relates to a card verification system and a method for detecting illegal use of a card.

2. Description of the Related Art

In recent years, card settlements using credit cards, electronic money cards, debit cards, etc. have increased. With the increase of card settlements, however, damage caused by skimming has also increased. Particularly, in the case of credit cards, since credit approval is given, damage is less likely to be detected unless the credit limit has been exceeded. The damage may be often found only after the credit card statement, sent after the fact, is checked.

If skimming damage is noticed at the time of statement checking and if the damage is reported to the police thereafter, there is some period of time between the use of a fraudulent card and the start of investigation. Accordingly, a salesperson subject to the fraud may not be able to recount events fully, and/or security camera footage may be often erased. Therefore, more effective investigation methods are currently required in order to reduce skimming crimes. Even though card information is skimmed, if a fraudulent card created based on the skimmed card information can be made unavailable, the card company or the cardholder will not sustain any actual damage. Accordingly, an authentication method other than a PIN number, or other authentication methods vulnerable to skimming, is required.

The present invention has been made in view of such a situation, and a purpose thereof is to provide a technique for reducing damage caused by card skimming.

### SUMMARY OF THE INVENTION

A card verification system of an embodiment of the present invention includes: a fraud detection-use card information storage unit that stores card information indicating that subsequent use of a card is regarded as illegal use; and

an illegal use information notification unit that notifies a predetermined information system about illegal use of the card, the illegal use information including location of where the card was used, when a settlement system has received a settlement request from a card reading terminal device with card information identical to card information registered in the fraud detection-use card information storage unit.

Optional combinations of the aforementioned constituting elements, and implementations of the present invention in the form of methods, apparatuses, systems, recording media, and computer programs may also be practiced as additional modes of the present invention.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a block diagram that shows a configuration of a card settlement system according to an embodiment of the present invention;

FIG. 2 is a block diagram that shows a configuration of a card reading terminal device shown in FIG. 1;

FIG. 3 is a block diagram that shows a configuration of a settlement system shown in FIG. 1;

FIG. 4 is a block diagram that shows a configuration of a card verification system shown in FIG. 1;

FIG. 5 is a block diagram that shows a configuration of a mobile terminal device shown in FIG. 1;

FIG. 6 is a flowchart that shows a procedure of processing performed in the card settlement system according to the embodiment;

FIG. 7 is a diagram that shows an example of an affiliated shop information table provided in an affiliated shop information storage unit of the settlement system according to the embodiment;

FIG. 8 is a diagram that shows an example of a detection information table provided in a detection-use card information storage unit of the card verification system according to the embodiment;

FIGS. 9A-9D are diagrams that each show an example of a message displayed on a display unit of the card reading terminal device;

FIG. 10 is a flowchart that shows a procedure of processing performed in the card settlement system according to an embodiment; and

FIG. 11 is a block diagram that shows a configuration of a card verification system dedicated to criminal investigation using a fraudulence detection card.

### DETAILED DESCRIPTION OF THE INVENTION

The invention will now be described by reference to the preferred embodiments. This does not intend to limit the scope of the present invention, but to exemplify the invention.

In recent years, damage to credit cards caused by skimming has become widespread. Because the card is in hand, the victim notices the skimming damage only after receiving a credit card statement. Unlike pickpocketing or robbery, skimming is noticed after a period of time, causing delay. Also, it is extremely difficult for the victim to identify the place where the damage occurred.

Major methods of skimming crimes are as follows: installing a skimming device on an automatic teller machine (ATM) to read card information and stealing its password or pin using a miniature camera or a dummy numeric keypad; and having a staff member of a business, such as a restaurant or a hotel, illegally steal card information while the staff member handles the card.

Credit card authentication is generally performed by allowing the user to sign or to enter a password. However, the signature or password is often stolen concurrently with the skimming of card information.

The crime of skimming is difficult to detect and hence is a crime where the criminal is difficult to track down and arrest. The type of such a criminal group is called a “hit-and-run” type, and the criminal group operates while moving from place to place; accordingly, even if damage can be promptly detected, finding and arresting the criminal will be difficult. Also, such a criminal group forms a hierarchy with the leader at the top; the role of stealing card information, and the role of actually using a fraudulent card, performed by withdrawers, is at the bottom of the hierarchy. As such, even if a withdrawer can be caught, it will be difficult to reach the leader of the group. Therefore, through conventional police stakeouts or prompt detection of skimming devices, it is difficult to eliminate skimming crimes. As follows, a card settlement system 1 for enabling a new investigation method effective for detection of skimming crimes is described as an embodiment.

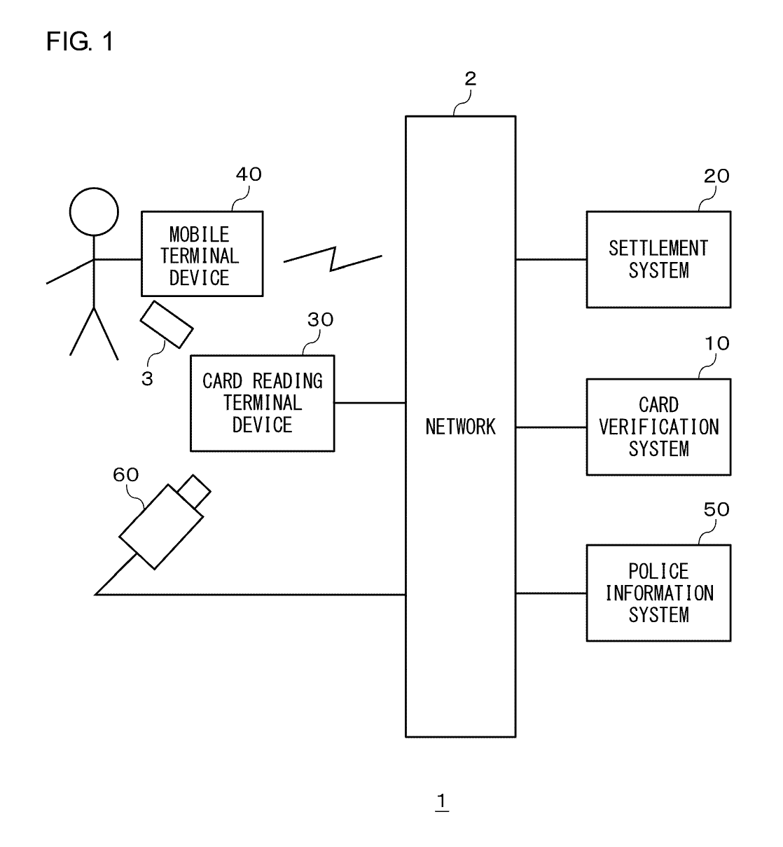

FIG. 1 is a block diagram that shows a configuration of a card settlement system 1 according to an embodiment of the present invention. In the card settlement system 1 according to an embodiment, a settlement system 20, a card verification system 10, a card reading terminal device 30, and a mobile terminal device 40 are used. Also, the card settlement system 1 works in cooperation with a police information system 50. Further, the card settlement system 1 works in cooperation with a security camera 60 installed in an affiliated shop, as needed. The card verification system 10, card reading terminal device 30, and mobile terminal device 40 are connected to one another via a network 2. The network 2 represents a communication channel, and the communication medium or protocol thereof is not limited; however, a high-security communication protocol, such as SSL communication, should be desirably used.

The card reading terminal device 30 is a terminal device provided with a function to read information of a card 3 presented or inserted by a cardholder. For example, the card reading terminal device 30 may be a cash register connected to a card reader, an ATM, a handy terminal, or a tablet terminal with a card reader provided externally. In the description of the embodiment, it is mainly assumed to be a cash register connected to a card reader. With this type of the card reading terminal device 30, a salesperson receives a card 3 from a customer and inserts the card 3 into the card reader, so that the card information is transferred into the cash register.

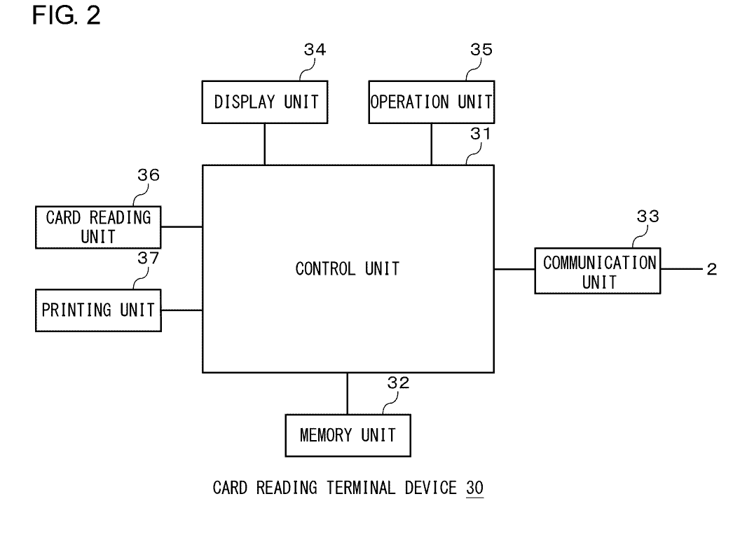

FIG. 2 is a block diagram that shows a configuration of the card reading terminal device 30 shown in FIG. 1. The card reading terminal device 30 comprises a control unit 31, a memory unit 32, a communication unit 33, a display unit 34, an operation unit 35, a card reading unit 36, and a printing unit 37. Card information read by the card reading unit 36 from a card 3 is output to the control unit 31. The control unit 31 connects to the network 2 via the communication unit 33 and notifies the settlement system 20 of a settlement request. The control unit 31 conveys the settlement request at least including the card information read by the card reading unit 36 and affiliated shop information retrieved from the memory unit 32.

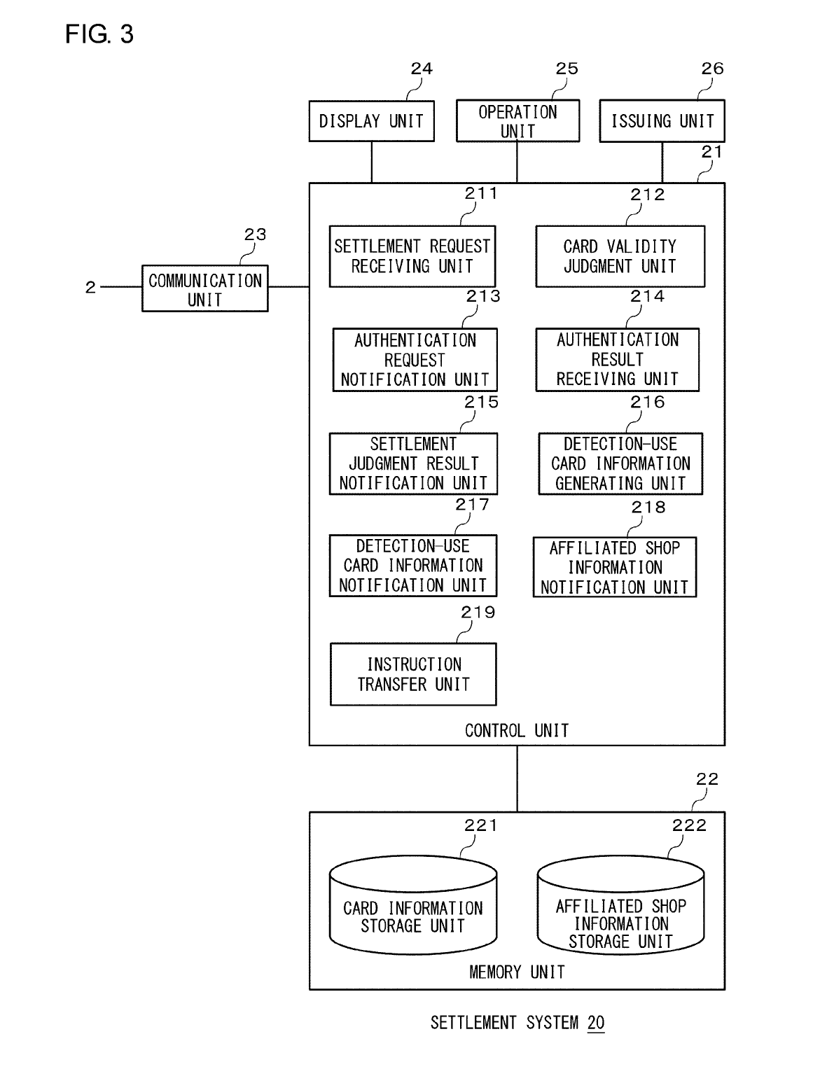

FIG. 3 is a block diagram that shows a configuration of the settlement system 20 shown in FIG. 1. The settlement system 20 is provided in a data center of a card company or of a system operation company commissioned by a card company. The settlement system 20 generally consists of multiple servers. Also, the settlement system 20 may be constituted by servers installed in multiple locations connected by cloud computing.

The settlement system 20 comprises a control unit 21, a memory unit 22, a communication unit 23, a display unit 24, an operation unit 25, and an issuing unit 26. The control unit 21 includes a settlement request receiving unit 211, a card validity judgment unit 212, an authentication request notification unit 213, an authentication result receiving unit 214, a settlement judgment result notification unit 215, a detection-use card information generating unit 216, a detection-use card information notification unit 217, an affiliated shop information notification unit 218, and an instruction transfer unit 219. FIG. 3 only shows the functional blocks of the control unit 21 related to the processes featured in the embodiment. The functions of the control unit 21 can be implemented by cooperation between hardware resources and software resources or only by hardware resources. As hardware resources, processors, ROMs, RAMS, LSIs, or the likes can be employed. As software resources, operating systems, applications, and other programs can be employed. The memory unit 22 may be constituted by an HDD or SSD, for example, and includes a card information storage unit 221 and an affiliated shop information storage unit 222. FIG. 3 also only shows the functional blocks of the memory unit 22 related to the processes featured in the embodiment.

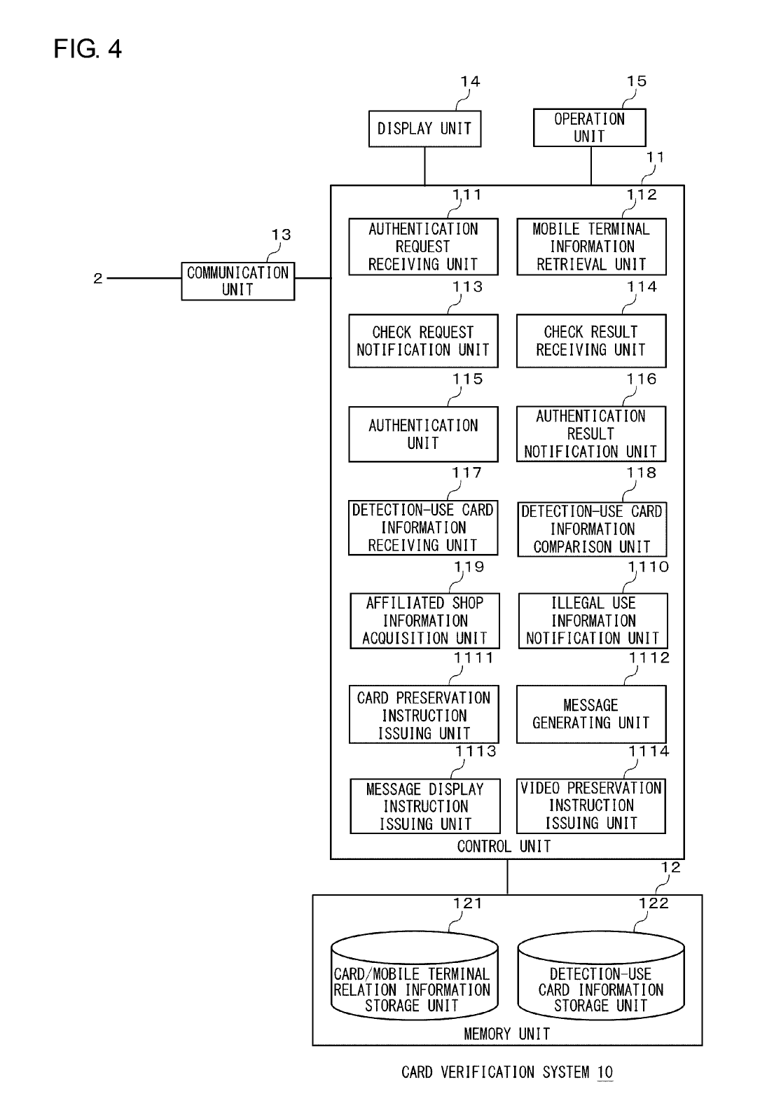

FIG. 4 is a block diagram that shows a configuration of the card verification system 10 shown in FIG. 1. The card verification system 10 may be possessed by another entity instead of a card company or by a card company itself. The card verification system 10 is also provided in a data center of the owner or of a system operation company commissioned by the owner. The card verification system 10 generally consists of multiple servers. Also, the settlement system 20 and card verification system 10 may be unified and integrally operated.

The card verification system 10 comprises a control unit 11, a memory unit 12, a communication unit 13, a display unit 14, and an operation unit 15. The control unit 11 includes an authentication request receiving unit 111, a mobile terminal information retrieval unit 112, a check request notification unit 113, a check result receiving unit 114, an authentication unit 115, an authentication result notification unit 116, a detection-use card information receiving unit 117, a detection-use card information comparison unit 118, an affiliated shop information acquisition unit 119, an illegal use information notification unit 1110, a card preservation instruction issuing unit 1111, a message generating unit 1112, a message display instruction issuing unit 1113, and a video preservation instruction issuing unit 1114. FIG. 4 also only shows the functional blocks of the control unit 11 related to the processes featured in the embodiment. The functions of the control unit 11 can be implemented by cooperation between hardware resources and software resources or only by hardware resources. The memory unit 12 may be constituted by an HDD or SSD, for example, and includes a card/mobile terminal relation information storage unit 121 and a detection-use card information storage unit 122. FIG. 4 also only shows the functional blocks of the memory unit 12 related to the processes featured in the embodiment.

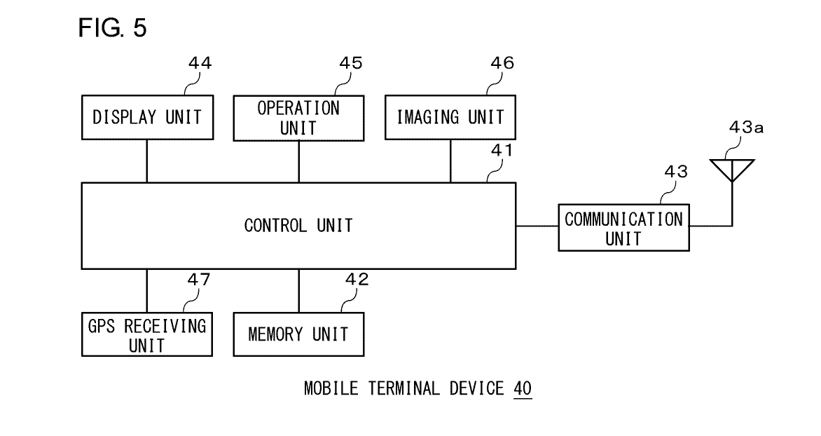

FIG. 5 is a block diagram that shows a configuration of the mobile terminal device 40 shown in FIG. 1. The mobile terminal device 40 is a terminal device carried by a holder of a card 3. For the mobile terminal device 40, a smartphone, a feature phone, a tablet, a portable music player, or a portable game device may be used, for example. Since a communication function is required in the embodiment, when a tablet, a portable music player, or a portable game device is used, such a device needs to be used with a SIM card inserted thereto or while being connected to an access point of a wireless LAN.

The mobile terminal device 40 comprises a control unit 41, a memory unit 42, a communication unit 43, an antenna 43a, a display unit 44, an operation unit 45, an imaging unit 46, and a GPS receiving unit 47.

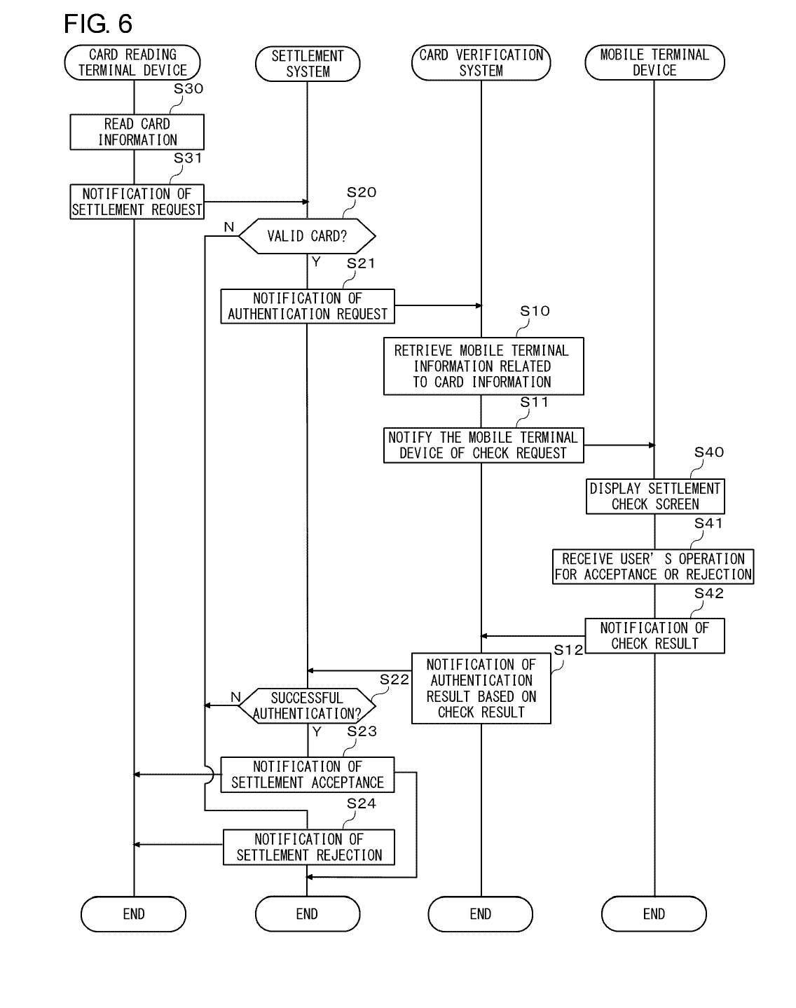

FIG. 6 is a flowchart that shows a procedure of processing performed in the card settlement system 1 according to the embodiment. Upon insertion of a card 3, the card reading unit 36 of the card reading terminal device 30 reads the card information (S30), and the control unit 31 then notifies the settlement system 20 of a settlement request including the card information thus read (S31).

Accordingly, the card validity judgment unit 212 judges whether or not the card information included in the settlement request is valid (S20). If the card information is invalid (N at S20), the settlement judgment result notification unit 215 will notify the card reading terminal device 30 of rejection of the settlement (S24). If the card information is valid (Y at S20), the authentication request notification unit 213 will notify the card verification system 10 of an authentication request (S21).

Accordingly, the mobile terminal information retrieval unit 112 of the card verification system 10 retrieves, from the card/mobile terminal relation information storage unit 121, mobile terminal information related to the card information according to the authentication request (S10). Based on the mobile terminal information, the check request notification unit 113 notifies the registered mobile terminal device 40 of a check request (S11).

Upon reception of the check request, the control unit 41 of the mobile terminal device 40 allows the display unit 44 to display a settlement check screen (S40). Thereafter, the control unit 41 of the mobile terminal device 40 receives, via the operation unit 45, the user's operation for acceptance or rejection of the settlement (S41) and notifies the card verification system 10 of a check result in which the user's operation is reflected (S42).

Accordingly, the authentication result notification unit 116 of the card verification system 10 notifies the settlement system 20 of an authentication result based on the check result (S12). If the authentication is successful (Y at S22), the settlement judgment result notification unit 215 of the settlement system 20 will notify the card reading terminal device 30 of acceptance of the settlement (S23). If the authentication is unsuccessful (N at S22), the settlement judgment result notification unit 215 will notify the card reading terminal device 30 of rejection of the settlement (S24).

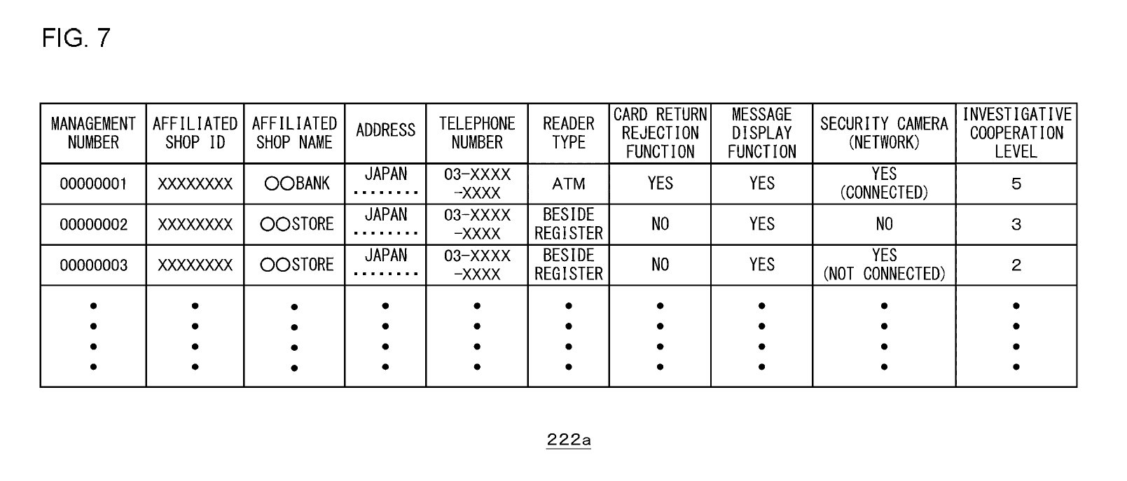

FIG. 7 is a diagram that shows an example of an affiliated shop information table 222a provided in the affiliated shop information storage unit 222 of the settlement system 20 according to the embodiment. Specific description will be provided later.

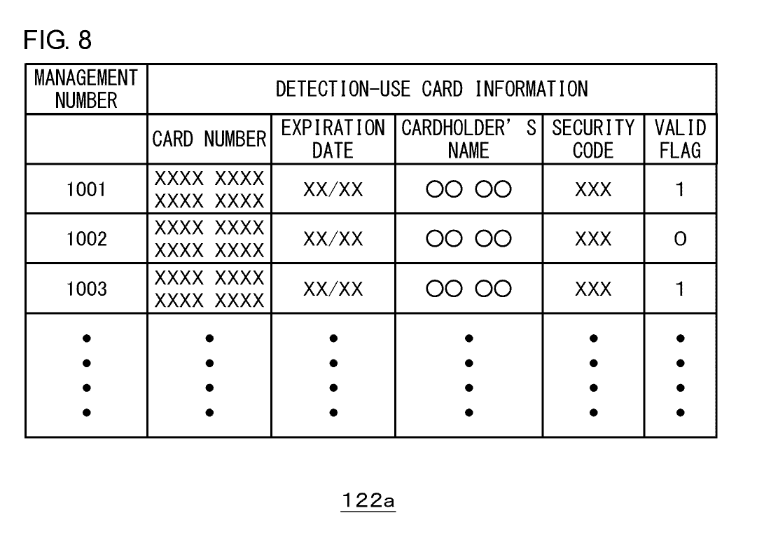

FIG. 8 is a diagram that shows an example of a detection information table 122a provided in the detection-use card information storage unit 122 of the card verification system 10 according to the embodiment. Specific description will be provided later.

The investigative authorities request a card company to issue a card used to detect fraud. Accordingly, the card company creates, for example, a card of which the first use is regarded as normal use and of which the second or later use is regarded as illegal use (hereinafter, such a card will be referred to as a one-time card). The one-time card has the same appearance as a normal card but contains different card information. The detection-use card information generating unit 216 of the settlement system 20 generates card information for fraud detection according to the request from the investigative authorities and transmits the card information to the issuing unit 26. Accordingly, the issuing unit 26 issues a fraud detection card containing the card information. In the card information storage unit 221, information of a fraud detection card having the same data structure as information of a normal card is registered. The detection-use card information notification unit 217 then notifies the card verification system 10 of the information of the fraud detection card.

The detection-use card information receiving unit 117 of the card verification system 10 receives the card information from the settlement system 20 and registers the card information in the detection-use card information storage unit 122. As shown in FIG. 8, detection-use card information includes a valid flag in addition to the items of normal card information. The valid flag is set to “0 (non-active)” when the detection-use card is in a normal use mode and is set to “1 (active)” when the detection-use card is in a detection mode. In the state where a card has not been used since the issuance of the card, the valid flag is set to “0”. Once a one-time card is used, the valid flag is changed from “0” to “1”. Card information in which the valid flag is “1” corresponds to card information indicating that the next use of the card will be regarded as illegal use.

After the card is used in multiple card reading terminal devices 30 to be investigated, the mode may be switched from the normal use mode to the detection mode. When a card reading terminal device 30 assumed to be used for skimming cannot be identified, a trap is sometimes set by allowing a number of card reading terminal devices 30 to read card information of a detection-use card. In this case, after the card information is read by multiple card reading terminal devices 30, the mode may be switched from the normal use mode to the detection mode.

In the following, it will be assumed as an example that a different one-time card is used for each card reading terminal device 30 to be investigated. In this case, the place where skimming occurred can be uniquely identified. The issued one-time cards are distributed to investigators of the investigative authorities. By identifying a shop or an ATM mutually used by multiple skimming victims, the investigative authorities can identify a candidate of shops and ATMs with a strong possibility of being used for skimming. There is also a case where a candidate of shops and ATMs with a strong possibility of being used for skimming can be identified based on information provided by a citizen or an insider.

An investigator uses a one-time card at a shop or an ATM with a strong possibility of being used for skimming. Namely, the investigator allows a card reading terminal device 30 to be investigated to read the card information of the one-time card. The settlement request receiving unit 211 of the settlement system 20 receives from the card reading terminal device 30 a settlement request including the card information of the one-time card. The card validity judgment unit 212 then judges the validity of the card information included in the settlement request. In the card information storage unit 221, card information of a one-time card is also registered in a data structure same as that of normal card information. Accordingly, the card validity judgment unit 212 judges the card information of the one-time card to be valid.

The authentication request notification unit 213 notifies the card verification system 10 of an authentication request including the card information of the one-time card. Accordingly, the authentication request receiving unit 111 of the card verification system 10 receives the authentication request from the settlement system 20. The detection-use card information comparison unit 118 then compares the card information with detection-use card information stored in the detection-use card information storage unit 122. When it is card information of a one-time card, there is card information identical therewith in the detection-use card information storage unit 122.

Accordingly, the detection-use card information comparison unit 118 retrieves the identical detection-use card information from the detection-use card information storage unit 122 and checks the valid flag therein. When the valid flag is “0”, the flag is changed to “1” and the information in the detection-use card information storage unit 122 is overwritten accordingly. After the valid flag is changed to “1”, normal authentication processing is performed for the authentication request. When the valid flag is “1”, in order to acquire detailed information of the affiliated shop, the affiliated shop information acquisition unit 119 notifies the settlement system 20 of an acquisition request for acquiring the affiliated shop information.

Accordingly, the affiliated shop information notification unit 218 of the settlement system 20 retrieves the requested affiliated shop information from the affiliated shop information storage unit 222 and notifies the card verification system 10 thereof. In the embodiment, as affiliated shop information, investigation information for facilitating detection of illegal use is also registered, in addition to the basic information including an address and a telephone number. In the example shown in FIG. 7, the type of the reader, whether or not a card return rejection function is provided, whether or not a message display function is provided, whether or not a security camera is installed, whether or not the security camera is connected to the network, and the investigative cooperation level are registered as the investigation information.

The readers fall roughly into two types: attended devices operated by users providing products or services; and unattended devices operated by cardholders themselves. A typical unattended device is an ATM. With a credit card with a caching function, by inserting the credit card into an ATM of a financial institute, a loan can be taken out up to a credit limit set by the card company. Namely, if the card information and PIN number of the credit card is leaked, there will be a risk of having money withdrawn.

The card return rejection function may be provided in a type of reader that holds the entire card or a large portion of the card to read the card information inside. For example, there are ATMs provided with a function to keep, when a fraudulent card such as a forged card is inserted thereto, the inserted card inside so as not to return the card. A general swipe-type reader is not provided with such a card return rejection function.

The message display function is a function to display, on the display unit 34 of the card reading terminal device 30, information for a user providing a product or service. Since displaying a message for requesting investigative cooperation from a salesperson is basically considered, this function is provided for an attended device.

Whether or not there is a security camera 60 capturing images of the card reading terminal device 30 is registered. In addition, whether the security camera 60 is connected to the network 2 and remotely operable or is operated in a stand-alone mode is also registered.

The investigative cooperation level is set in advance for an affiliated shop by a card company or the investigative authorities together with the affiliated shop. There are five investigative cooperation levels in the description of the embodiment, with “5” as the highest level and “1” as the lowest level. The level “5” is selected for an affiliated shop that actively helps investigation by prolonging a withdrawer's stay at the register or holding a withdrawer, and the level “1” is selected for an affiliated shop that is reluctant to get involved in criminal investigation.

The affiliated shop information acquisition unit 119 in the card verification system 10 acquires affiliated shop information from the settlement system 20. The illegal use information notification unit 1110 then notifies the police information system 50 via the network 2 of card illegal use information including the place where the fraudulent card was used, included in the affiliated shop information. For example, the illegal use information notification unit 1110 may notify the police information system 50 in the country where the fraudulent card was used. When the police information system 50 receives the card illegal use information from the card verification system 10, an investigator near the place where the fraudulent card was used is ordered to head for the site. For example, an investigator is informed of use of a fraudulent card by police radio by an investigation team of which the jurisdiction covers the place where the fraudulent card was used.

In some countries, a special organization other than the police may have investigation authority to detect card crimes. In this case, card illegal use information is conveyed to an information system in the organization. Alternatively, card illegal use information may be conveyed to an information system in a mass medium, such as a newspaper and a TV station. By allowing mass media to cover skimming crimes, raising public interest in skimming crimes can be expected.

When the affiliated shop information indicates that the card return rejection function is provided, the card preservation instruction issuing unit 1111 issues a fraudulent card preservation instruction for ordering that the card 3 inserted into the card reading unit 36 of the card reading terminal device 30 be kept inside the card reading unit 36. The fraudulent card preservation instruction is then transmitted to the settlement system 20, and the instruction transfer unit 219 in the settlement system 20 notifies the card reading terminal device 30 of the fraudulent card preservation instruction. When the card reading terminal device 30 cannot directly control the card reading terminal device 30, an information system in the financial institute in which the card reading terminal device 30 is provided is requested to preserve the card 3 inserted into the card reading unit 36. Since the illegally used card 3 may have fingerprints of a withdrawer or another member of the criminal group left thereon, preserving the illegally used card will be preservation of evidence.

When the affiliated shop information indicates that a security camera is installed and the security camera is connected to the network, the video preservation instruction issuing unit 1114 issues a video preservation instruction for ordering that video data captured by the security camera 60 be preserved. The video preservation instruction is then transmitted to the settlement system 20, and the instruction transfer unit 219 in the settlement system 20 notifies a control system for the security camera 60 of the video preservation instruction. Since video images from the security camera 60 are generally erased after a retention period, preservation of at least video images captured at the date and time when the card was illegally used is requested. The video preservation instruction may include a message for requesting submission of video images capturing a user who has illegally used the card to the investigative authorities.

When the security camera 60 is a type of camera of which the image quality including the resolution and frame rate can be adjusted by setting, the video preservation instruction issuing unit 1114 may instruct the control system for the security camera 60 to increase the image quality.

When the affiliated shop information indicates that the message display function is provided, the message generating unit 1112 generates a message to be displayed on the display unit 34 of the card reading terminal device 30. The message generating unit 1112 generates a message based on the investigative cooperation level, whether or not a security camera is installed, and whether or not the security camera is connected to the network, which are included in the affiliated shop information, and also based on the investigation policy of the police.

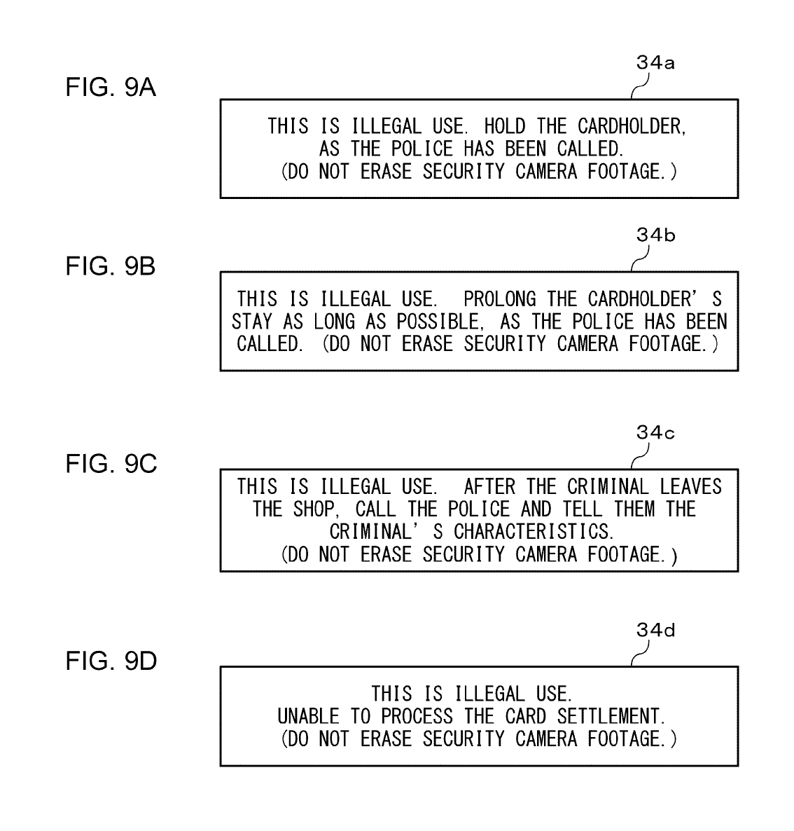

FIGS. 9A-9D are diagrams that each show an example of a message displayed on the display unit 34 of the card reading terminal device 30. FIG. 9A shows an example of a message for the case where the investigative cooperation level is “5” and a hardened security guard, for example, is allocated within the shop. When a stand-alone security camera 60 is installed, an alerting message, such as “Do not erase the camera footage”, may be added. Video images stored in the memory of the stand-alone security camera 60 are overwritten in a short period of time (in a day, for example) in order to save the memory. Accordingly, it is preferable to display such an alerting message for preservation of video images from the security camera 60.

FIG. 9B shows an example of a message for the case where the investigative cooperation level is “4” or “5”. When a hardened security guard, for example, is not allocated within the shop, even if the investigative cooperation level is “5”, the message of FIG. 9B is selected instead of the message of FIG. 9A. After checking the message of FIG. 9B, the salesperson tries to gain time by requesting the user to fill in a personal information form, for example. Gaining time enables an investigator to get closer to the shop.

There may be an investigation policy of tracking a withdrawer so as to apprehend the withdrawer making contact with an upper member, rather than holding the withdrawer in the shop. In the case of this investigation policy, even if the investigative cooperation level is “5” and a hardened security guard is allocated within the shop, the message of FIG. 9B is selected instead of the message of FIG. 9A. This investigation method is effective especially when an investigator has been staking out the shop.

FIG. 9C shows an example of a message for the case where the investigative cooperation level is “2” or “3”. The message requests a salesperson to call the police without requesting a large burden on the salesperson. Shortly after a withdrawer left the shop, the salesperson who has dealt with the withdrawer vividly remembers the looks and clothes of the withdrawer or the direction in which the withdrawer fled. Also, upon display of the message, the salesperson will observe the customer more carefully. The call from the salesperson helps the investigative authorities to accurately and promptly acquire information on the withdrawer, which can be used for the initial investigation.

FIG. 9D shows an example of a message for the case where the investigative cooperation level is “1” or “2”. In the case of an affiliated shop that is negative about investigative cooperation, the shop is requested to reject settlement for use of a fraudulent card. When the investigative cooperation level is “2” and a stand-alone security camera 60 is installed, preservation of video images from the security camera 60 may be requested.

The message display instruction issuing unit 1113 of the card verification system 10 issues a message display instruction for instructing the display unit 34 of the card reading terminal device 30 to display a message generated by the message generating unit 1112. The message display instruction is then transmitted to the settlement system 20, and the instruction transfer unit 219 in the settlement system 20 notifies the card reading terminal device 30 of the message display instruction.

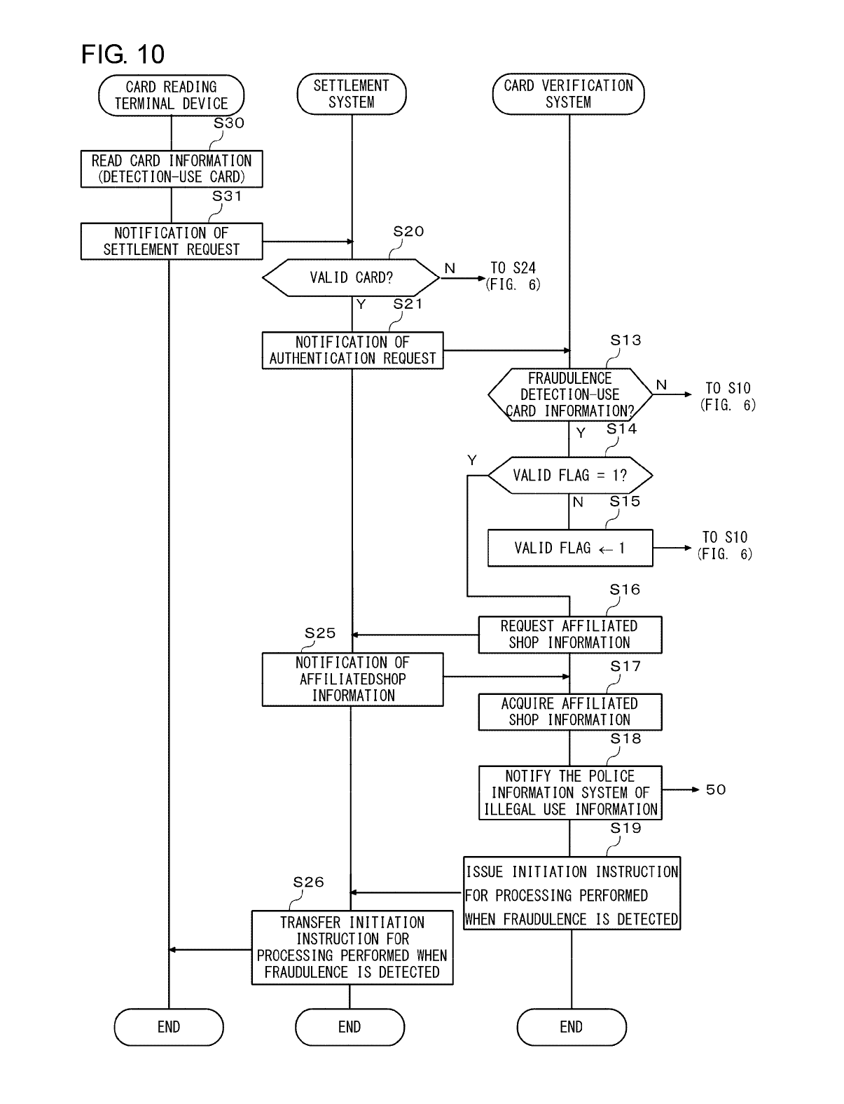

FIG. 10 is a flowchart that shows a procedure of processing performed in the card settlement system 1 according to the embodiment. Upon insertion of a card 3 for fraud detection, the card reading unit 36 in the card reading terminal device 30 reads the card information (S30), and the control unit 31 then notifies the settlement system 20 of a settlement request including the card information thus read (S31).

Accordingly, the card validity judgment unit 212 determines whether or not the card information included in the settlement request is valid (S20). If the card information is invalid (N at S20), the process will skip to the step S24 in FIG. 6. If the card information is valid (Y at S20), the authentication request notification unit 213 will notify the card verification system 10 of an authentication request (S21).

Accordingly, the detection-use card information comparison unit 118 of the card verification system 10 makes a comparison to determine whether or not there is a piece of card information registered in the detection-use card information storage unit 122 that is identical with the card information for which the authentication request has been transmitted from the settlement system 20 (S13). If there is no identical card information (N at S13), the process will skip to the step S10 in FIG. 6. If there is identical card information (Y at S13), the valid flag of the identical card information is checked (S14). When the valid flag is “0” (N at S14), the detection-use card information comparison unit 118 changes the valid flag from “0” to “1” (S15). Thereafter, the process will skip to the step S10 in FIG. 6.

When the valid flag is “1” (Y at S14), the affiliated shop information acquisition unit 119 notifies the settlement system 20 of an acquisition request for acquiring the affiliated shop information (S16). Upon reception of the acquisition request, the affiliated shop information notification unit 218 in the settlement system 20 retrieves the corresponding affiliated shop information from the affiliated shop information storage unit 222 and notifies the card verification system 10 thereof (S25). Accordingly, the affiliated shop information acquisition unit 119 in the card verification system 10 acquires the affiliated shop information thus conveyed by the settlement system 20 (S17).

The illegal use information notification unit 1110 notifies the police information system 50 of card illegal use information including an address included in the acquired affiliated shop information (S18). An instruction issuing unit issues an instruction for initiating processing to be performed in the affiliated shop when fraud is detected (S19), and the instruction transfer unit 219 of the settlement system 20 transfers the issued instruction to at least one of the card reading terminal device 30, an information system in the shop, and an information system for the security camera 60 (S26).

In the embodiment described above, when a one-time card of which the valid flag is active is used, it can be regarded as deliberate illegal use. The withdrawer who knows the circumstances can be arrested on the spot. Even if a person has asked another person, who does not know the circumstances, to use the card, the person who has asked the another person will be an indirect perpetrator. Conventionally, at the time when a withdrawer uses a fraudulent card, the victim generally has not noticed the skimming damage and hence has not filed a damage report yet. Accordingly, it has been legally difficult to arrest the withdrawer on the spot, even though the withdrawer's behavior seemed to be suspicious.

A one-time card has the same appearance as a normal card and can be normally used when the valid flag thereof is non-active. Accordingly, a person who has illegally obtained the card information and PIN number of the one-time card uses them without noticing that they are the card information and PIN number prepared for fraud detection.

In the embodiment, investigation can be promptly initiated after an illegal use, so that the evidence can be preserved and a witness's memory will be reliable. In addition, if the withdrawer can be tracked, reaching an upper member of the criminal group can also be expected.

Also, if such an investigation method becomes widely known, a restraining effect on use of fraudulent cards can be expected. There have been an increasing number of cases where a person conspiring to use a fraudulent card purchases skimmed card information and PIN number through the Internet so as to make a fraudulent card. In this case, since the person who skimmed the card and the person who used the fraudulent card are less connected to each other, arresting the both persons is difficult.

However, if persons who are to use fraudulent cards feel the risk of being arrested at the time of use of the fraudulent cards, an increasing number of the persons will be discouraged from causing a crime. Accordingly, it is expected that the demand for skimmed card information will be decreased, and the sales of skimmed card information of a seller will also be decreased. With such a mechanism, it can be expected that the number of skimming crimes will be gradually decreased.

The present invention has been described with reference to the embodiments. The embodiments are intended to be illustrative only, and it will be obvious to those skilled in the art that various modifications to a combination of constituting elements or processes could be developed and that such modifications also fall within the scope of the present invention.

In the embodiment, there has been described the card settlement system 1 for enabling both an authentication method using the mobile terminal device 40 and criminal investigation using a card 3 for fraud detection. Alternatively, a card settlement system 1 dedicated to criminal investigation using a card 3 for fraud detection may be constructed.

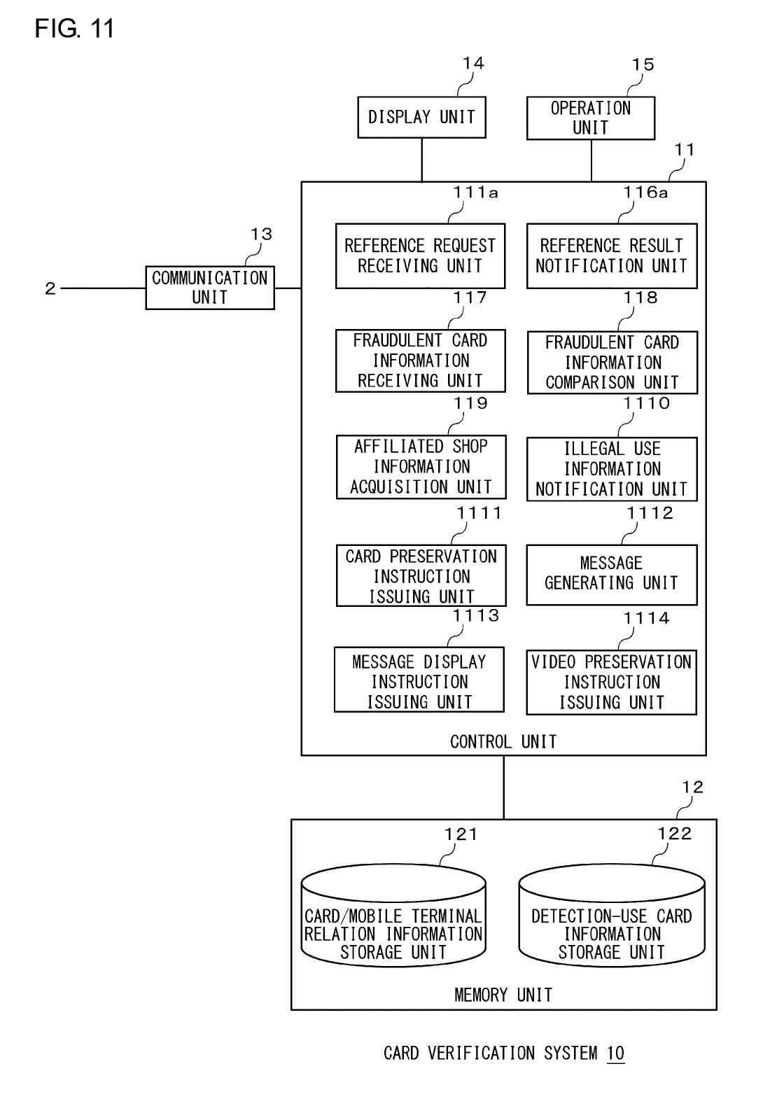

FIG. 11 is a block diagram that shows a configuration of a card verification system 10 dedicated to criminal investigation using a card 3 for fraud detection. Compared to the card verification system 10 shown in FIG. 4, the mobile terminal information retrieval unit 112, check request notification unit 113, check result receiving unit 114, and authentication unit 115 can be omitted in the card verification system 10 shown in FIG. 11. Also, instead of an authentication request, a reference request for requesting a reference regarding whether or not it is card information of a detection-use card is transmitted from the settlement system 20. Accordingly, a reference request receiving unit 111a and a reference result notification unit 116a are provided instead of the authentication request receiving unit 111 and authentication result notification unit 116.

In the above description, a card 3 is assumed to be a credit card, but it may also be a bank ATM card, an electronic money card, or a debit card.

What is claimed is:

1. A card verification system, comprising:
a fraud detection-use card information storage unit that stores card information indicating that subsequent use of a card is regarded as illegal use; and
an illegal use information notification unit that notifies a predetermined information system about illegal use of the card, the illegal use information including location of where the card was used, when a settlement system has received a settlement request from a card reading terminal device with card information identical to card information registered in the fraud detection-use card information storage unit.

2. The card verification system of claim 1, wherein the fraud detection-use card information storage unit stores card information indicating illegal use, when the number of uses is a predetermined number or less, the use is regarded as normal use, and, when the number uses exceeds the predetermined number, the use is regarded as illegal use, and
wherein, when a settlement system has received a settlement request from a card reading terminal device with card information identical to card information registered in the fraud detection-use card information storage unit and when the number of uses exceeds the predetermined number, the illegal use information notification unit notifies a predetermined information system of card illegal use information, including the place where a fraudulent card was used.

3. The card verification system of claim 2, wherein the predetermined number is one.

4. The card verification system of claim 2, wherein, when the number of uses is a predetermined number or less, the use is regarded as normal use, and, when the number uses exceeds the predetermined number, the use is regarded as illegal use, and the card information indicates that the card read by a card reading terminal device is to be investigated.

5. The card verification system of claim 2, wherein the card reading terminal device comprises a reading unit capable of keeping an inserted card inside, and
wherein the card verification system further comprises a card preservation instruction issuing unit that issues a fraudulent card preservation instruction for ordering that a card inserted into the reading unit be kept inside when card information, for which a request is made by a settlement system that has received a settlement request from the card reading terminal device, is identical with card information registered in the fraud detection-use card information storage unit and also when the number of uses exceeds the predetermined number.

6. The card verification system of claim 2, wherein the card reading terminal device comprises a display unit that displays information for a user providing a product or service, and
wherein the card verification system further comprises a message display instruction issuing unit that issues a message display instruction for instructing the display unit of the card reading terminal device to display a message for conveying illegal use when a settlement system has received a settlement request from the card reading terminal device with card information identical to card information registered in the fraud detection-use card information storage unit and when the number of uses exceeds the predetermined number.

7. The card verification system of claim 2, wherein:
a security camera capturing images of the card reading terminal device is installed; and
the card verification system further comprises a video preservation instruction issuing unit that issues a video preservation instruction for ordering that video data captured by the security camera be preserved a settlement system has received a settlement request from the card reading terminal device with card information identical to card information registered in the fraud detection-use card information storage unit and when the number of uses exceeds the predetermined number.

8. A method for detecting illegal use of a card, comprising:
a first step of receiving an authentication request from a settlement system that has received a settlement request from a card reading terminal device that has read a card of which the next use is regarded as illegal use;
a second step of determining whether or not information of the card is identical with card information registered in a fraud detection-use card information storage unit; and
a third step of notifying a predetermined information system, when the information of the card is identical with card information registered in the fraud detection-use card information storage unit, of card illegal use information including the place where a fraudulent card was used.

9. The method for detecting illegal use of a card of claim 8, wherein, in the first step, an authentication request is received from a settlement system that has received a settlement request from a card reading terminal device that has read a card of which use is regarded as normal use when the number of uses is a predetermined number or less and of which use is regarded as illegal use when the number of uses exceeds the predetermined number,
wherein, in the second step, whether or not information of the card is identical with card information registered in the fraud detection-use card information storage unit and also whether or not the number of uses is the predetermined number or greater is determined, and
wherein, in the third step, when the information of the card is identical with card information registered in the fraud detection-use card information storage unit and also when the number of uses is the predetermined number or greater, a predetermined information system is notified of card illegal use information including the place where a fraudulent card was used.
